(19) United States
(12) Patent Application Publication
(10) Pub. No.: US 2019/0392455 A1
(43) Pub. Date: Dec. 26, 2019

(54) WARRANTY PLATFORM

(71) Applicant: MACHINE COVER, INC., Wenham, MA (US)

(72) Inventor: Inder-Jeet Singh GUJRAL, Wenham, MA (US)

(21) Appl. No.: 16/521,293

(22) Filed: Jul. 24, 2019

Related U.S. Application Data
(63) Continuation-in-part of application No. 16/430,547, filed on Jun. 4, 2019.
(60) Provisional application No. 62/702,518, filed on Jul. 24, 2018.
(60) Provisional application No. 62/680,032, filed on Jun. 4, 2018.

(51) Int. Cl. G06Q 30/00

(52) U.S. Cl. CPC G06Q 30/012

(57) ABSTRACT

A method of establishing a condition-based warranty program includes defining a warranty type including a description of the warranty, an amount or range of a payout and a definition of conditions that trigger the payout, and measuring a probability of the trigger and determining a warranty price based on the measured probability and based on the amount or range of the payout. A first mechanism is established to determine whether and when the trigger has occurred, and a second mechanism is established to determine whether and when the payout is required. Protocols are established for warranty lifecycle management to manage possible circumstances that may occur once a particular warranty is sold.

### CROSS-REFERENCES TO RELATED APPLICATIONS

This application claims the benefit of U.S. Provisional Patent Application No. 62/702,518, filed Jul. 24, 2018, and this application is a continuation-in-part of U.S. patent application Ser. No. 16/430,547, filed Jun. 4, 2019, pending, which claims the benefit of U.S. Provisional Patent Application No. 62/680,032, filed Jun. 4, 2018, the entire contents of each of which are hereby incorporated by reference in this application.

### STATEMENT REGARDING FEDERALLY SPONSORED RESEARCH OR DEVELOPMENT

(NOT APPLICABLE)

### BACKGROUND

The invention relates to systems and methods for developing and administering warranties. More specifically, the invention relates to methods and systems for establishing a condition-based warranty program.

The United States property and casualty insurance market is roughly 450 billion dollars per year. Despite its size, the industry is essentially going sideways in terms of annual revenue. The industry relies on traditional channels (MGAs, agents, brokers) for the vast bulk of its revenue. The value-chain contains a large number of intermediaries, each of which has been historically “necessary.” The insurance industry business model relies upon an intervention-heavy way of determining the exact loss suffered by an insured, and then trying to find ways to minimize the payout related to that loss. Additionally, the insurance industry is heavily regulated, at the state level in the U.S. and at national levels in most other countries.

### BRIEF SUMMARY

Use of the term “warranty” in the described embodiments is unlike conventional warranties as currently understood for consumer products. The “warranty” of the described embodiments rather more closely resembles parametric insurance. Use of the term “warranty” is thus not intended to encompass a traditional definition.

There is a class of insurance problems where, if the conditions listed below can be satisfied, the result is an offering that is far simpler and likely far less regulated than insurance in general. Such an offering is generally referred to as a “warranty” and the described embodiments define a software “platform” that manages all aspects of the creation, sale and operation of such warranties.

(1) The general structure of any warranty offering is not dissimilar to an insurance contract—the buyer pays some amount of money and if something untoward (but rare) happens, the buyer stands to gain a considerably larger amount of money, presumably to (partly or wholly) compensate for the negative consequences of the untoward event. The possible amount the buyer may receive is referred to as the “payout”.

(2) The payout is fixed and is expressed as “you will get exactly X” rather than “you will get no more than X,” which would be the case in a conventional insurance contract.

(3) The condition that determines whether or not a payout is due, is externally and independently verifiable by all parties. Thus the warranty-holder may or may not “report a claim,” but in all cases, the circumstances leading to the payout becoming due are as visible to the warranty-issuer as they are to the warranty-buyer. This is significant because the universe of such determinations is rapidly expanding. For instance, information from IoT sensors, both consumer (house-alarms, dishwashers, refrigerators etc.) and industrial (tractors, jet engines, turbines etc.) can be used to detect precisely this kind of condition.

(4) The price of such a warranty is determinable not by some universal underwriting expertise, but by the “event history” of the events covered by the warranty. In other words, it is based primarily on the observed probability of the untoward event occurring, as seen across a statistically significant number of observations.

In an exemplary embodiment, a method of establishing a condition-based warranty program includes the steps of (a) defining a warranty type including a description of the warranty, an amount or range of a payout and a definition of conditions that trigger the payout; (b) measuring a probability of the trigger and determining a warranty price based on the measured probability and based on the amount or range of the payout; (c) establishing a first mechanism to determine whether and when the trigger has occurred, and establishing a second mechanism to determine whether and when the payout is required; and (d) establishing protocols for warranty lifecycle management to manage possible circumstances that may occur once a particular warranty is sold.

Step (b) may include an average payout frequency in any given time period, and a worst-case payout estimation for the given time period. Step (c) may be practiced with preemptive scanning. Step (c) may be further practiced by administrator analysis of circumstances reported by a warranty purchaser. Step (c) may be practiced by administrator analysis of circumstances reported by a warranty purchaser.

Step (d) may be practiced by defining a pricing protocol to determine whether and how to modify the warranty price. Step (d) may be practiced by defining communication protocols to notify a risk partner about the particular warranty. The communication protocols may include further notifications to the risk partner about a partner warranty fee due to the risk partner. Step (d) may be practiced by defining payment processing protocols to accept payment for the particular warranty. Step (d) may be practiced by defining data-gathering protocols to activate the first and second mechanisms. Step (d) may be further practiced by defining payout protocols to identify and confirm the trigger and to authorize the payout. Step (d) may be practiced by defining termination protocols to deactivate the first and second mechanisms when an in-force period of the warranty ends. Step (d) may be further practiced by defining renewal protocols to enable warranty renewal when the in-force period of the warranty ends, when the warranty may be canceled, or after the trigger. Step (d) may be practiced by defining reporting protocols to generate aggregate warranty reports.

### BRIEF DESCRIPTION OF THE DRAWINGS

These and other aspects and advantages will be described in detail with reference to the accompanying drawings, in which:

FIG. 1 is a flow diagram showing methods of administering a technology warranty;

FIG. 2 is a flow diagram showing details of establishing base lines;

FIG. 3 is a schematic illustration of a business model;

FIG. 4 is a flow diagram showing a method of establishing a condition-based warranty program according to the described embodiments; and

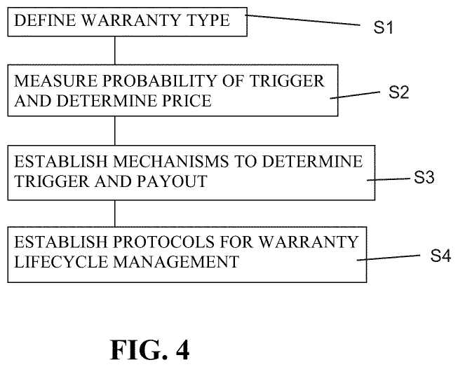

FIG. 5 is a schematic illustration of a computer system for the condition-based warranty program platform.

### DETAILED DESCRIPTION

A technology warranty is viable where the nature of the covered mishap is defined in advance, and the mechanism by which the occurrence of the mishap can be observed by any interested party is also defined in advance. That is, the fact of whether the mishap has occurred is not disputable, and it may be verified externally and independently by any interested party. A technology warranty thus protects companies from losses associated with technology aberrations resulting in a loss of business, connectivity, or the like.

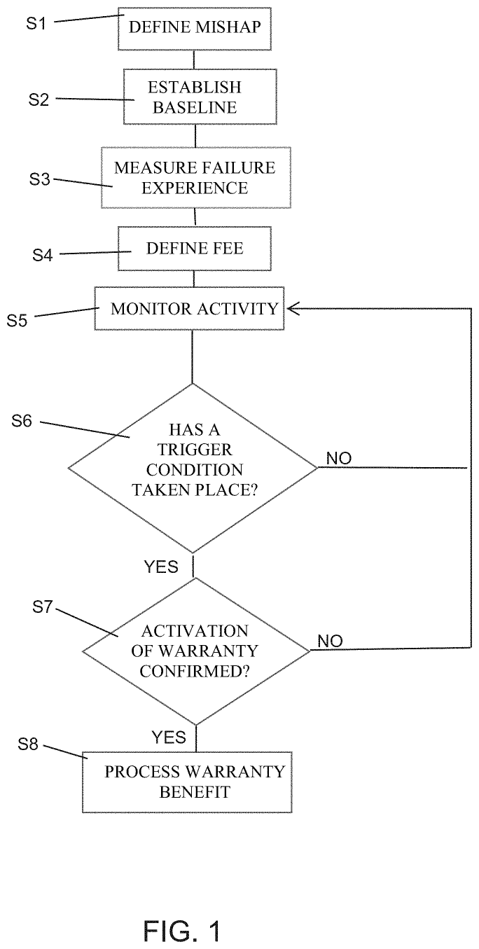

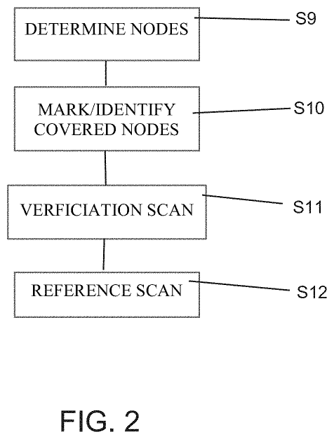

FIG. 1 is a flow diagram of the process for administering a technology warranty. Further details of the process steps are described below. In step S1, a mishap for coverage by the technology warranty is defined. As noted, the mishap should be identifiable and verifiable after occurrence. In some embodiments, the technology warranty may cover only one mishap, whatever its cause, where the warranty-holder's website either ceases to work at all, or if it does work, it serves web pages very sluggishly (the degree of ‘sluggishness’ is defined in a manner that is sufficient to trigger the warranty). A baseline operating parameter for which the mishap is applicable is established (S2). Details of the processes associated with establishing the baseline operating parameter will be described below with reference to FIG. 2.

In order to determine pricing for the technology warranty, a failure experience for the buyer and for the particular mishap is measured (S3), and a fee structure for the technology warranty can be defined based on the failure experience (S4). The failure experience or ‘impairment’ may be measured by asking the relevant website to serve a page, and it is determined whether the website cannot do so at all (in which case it is ‘down’) or it cannot do so within a defined amount of time (an exemplary threshold is that the first bytes of the requested page should show up within 15 seconds of the request being made).

In step S5, the buyer's website or other covered technology is monitored. Monitoring can be passive, where the warranty administrator receives a report of possible mishap occurrence from the warranty holder, or active, where the warranty administrator conducts a periodic analysis to determine a mishap occurrence. In some embodiments, the warranty administrator requests a page, and if the page is served with the defined threshold (e.g., 15 seconds), then the website is not impaired, otherwise, the website is impaired.

When a trigger condition has taken place (either reported by the warranty holder or detected by the warranty administrator) (YES in S6), activation of the technology warranty is confirmed (S7). In determining whether the trigger condition has taken place, a triggered operating parameter is compared with the baseline operating parameter, and the trigger condition is identified and confirmed when the triggered operating parameter satisfies predetermined trigger criteria (e.g., mishap, duration, limited to covered target, etc.). After determining the trigger condition and confirming the activation of the technology warranty, the warranty benefit is processed (S8).

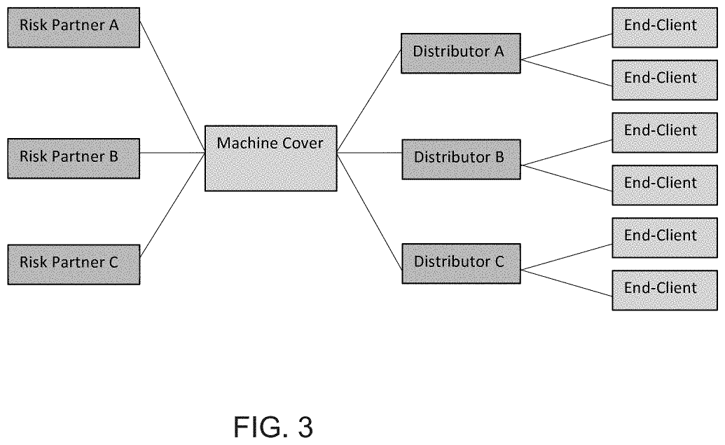

A warranty administrator defines and executes the warranties of all offered types with the support of the risk partners and the distributors. With reference to FIG. 3, the risk partners provide underwriting capacity. The exemplary model shows three such partners, but there may be 1 or 2 or N. A risk partner commits to the warranties in general, but this does not mean that they are legally bound to provide risk support for any specific warranty type—they may decline to cover the risk associated with it, while reserving the right to examine other warranty types for acceptance/rejection. Thus, a particular warranty type may be underwritten by a subset of all the risk partners.

In the most general case, a risk partner may commit a defined percentage of the payout for some warranty types but not others. Obviously a particular warranty type cannot be offered for sale unless 100% of its payout is covered by one or more risk partners.

Each distributor has a client base that may number in the hundreds or thousands. In all cases, the distributor already sells them technology-related products/services. A distributor may sell warranties to its clients by adding the warranty to the products or services it offers for sale, or by referring its clients to a warranty administrator.

A number of these distributors may be cyber-security companies that offer scans of their clients to determine traffic volume, infection, etc. Details of the scanning technology and process will thus not be further described. The cyber-security companies are thus also potentially providers of their scan technology to the warranty administrator. Thus, in the most general case, a distributor may be engaged with the warranty distributor in some or all of the following ways:

1. They sell the warranty administrator's warranties to their clients.

2. They refer their clients to the warranty administrator for the sale of warranties.

3. They license a ‘lite’ version of their scans to the warranty administrator for use in monitoring warranties.

4. Each warranty buyer being scanned using their ‘lite’ scans by the warranty administrator automatically becomes an upsell target for them to sell a ‘pro’ version of their services.

There is no reason why a provider of scans should also be a distributor, but given that most such companies have developed their scanning technology for sale to clients, it makes sense that if a company has both scan technology and clients, the warranty administrator could seek to engage with them as a distributor and also as a scan provider.

End clients are any entities that are exposed to cyber-risk or other technology risk.

Warranty types may be canned or custom. A canned warranty is one where the warranty administrator determines that there is a relatively universal problem that requires a general-purpose warranty and this warranty may be sold through multiple distributors/channels. However, coming up with such a warranty requires that the warranty administrator should come up with pricing, payouts and trigger conditions. An exemplary canned warranty covers a sharp drop in web traffic, wherein if the warranty holder pays $4K per month and if the agreed-upon mishap happens, the warranty administrator pay the warranty holder a fixed sum. Such a warranty can be offered via multiple distributors.

A custom warranty is where a distributor has a large number of clients and a specific externally-observable condition they would like to warrant against. In that case the design of the warranty (the price, the risk profile, the payout, etc.) would occur on a custom basis. A custom warranty offers a benefit that is specific to the end-clients of a given distributor and where the pricing of the warranty therefore depends on the historical experience of that distributor.

The general approach to warranty-pricing is to follow one of the following methods:

1. For canned warranties, the risk-partner(s) and the warranty administrator will model the warranty and agree upon a ‘base’ price as well as how this price will be split. This warranty will then be offered to all relevant distributors, with the expectation that the distributor will mark it up to whatever they think the market will bear. For example, a minimum may be 15% to bring it roughly on par with what a broker might get, but ultimately it is up to the distributor how to maximize revenue from the warranty.

2. For custom warranties, the risk-partner(s), the warranty administrator and the distributor will jointly model and agree upon the structure of the warranty, including a ‘base price’ which is what the distributor would be charged. The split between the risk-partner(s) and the warranty administrator will also be agreed upon. Once that is done, the distributor is free to mark it up as they want, as outlined in the previous example.

Determining the price for any warranty type will be described with reference to an example wherein a distributor detects malware and removes it when detected. The distributor may say “we find that in any given month, an average of 0.3% of our end-clients are found to be infected.” If they want to warrant against such infection, and they have a good sense of a ‘reasonable’ payout, the warranty administrator can calculate the long-run average aggregate payout per month, which can be used to arrive at a ‘floor’ price, i.e., one where the risk partner is highly unlikely to suffer a loss. For example, if we observe that 1% of websites are impaired each year, then if the warranty administrator charges any number more than 1% of the payout amount for impairment, that charge is guaranteed to at least meet the payout needs. This is defined as the minimum-necessary base price.

The warranty administrator acts as the intermediary between warranty distributors on the one hand, and providers of underwriting capacity on the other.

Specifically, the warranty administrator contributes as follows:

1. Distributors —it identifies and contracts with warranty distributors for both insurance as well as non-insurance channels.
A. Non-insurance brokers that provide technological products and/or services to the warranty buyers.
B. Insurance brokers are able to sell cyber-warranties as smaller versions of full cyber-policies for smaller companies, and also as cover for ‘the first million’ in larger cyber-policies. They are also able to sell warranties and then ‘upsell’ the client on full cyber-policies.

2. Studio—it offers a web-based software tool called the ‘studio’ which enables warranties to be defined and managed. In summary, defining a warranty means:
A. Modeling and then defining its price (i.e. its monthly fee) based on the failure experience of the distributor.
B. Modeling and then defining its payout (what the warranty-buyer gets if the warranty ‘triggers’) based on a range of numbers that is not so low as to be useless and not so high as to encourage fraud.
C. Defining the ‘trigger condition’ that causes the payout to be made.

3. Scans/Feeds—the scans/feeds that identify the initial condition of the domain/servers to which the warranty is to apply, that identify changes in them, and that monitor for the existence of the trigger condition. These are all available from numerous third party companies, but the warranty administrator can plug them all into a standard API so that even if a given warranty switches from scan A to B, the rest of the process is not affected.

4. Lifecycle Management—the series of transactions that occur during the lifecycle of any warranty—its initiation, its termination, the setting of its price, its auto-renewal with a (possibly) different price and so on, are all managed by the warranty administrator.

5. Risk partners—the warranty administrator arranges to ‘place’ each warranty type with one or more risk-capital partners by working out an agreed-upon price, negotiating the part of the warranty fee that each such partner will receive, etc.

Exemplary canned warranties may include:

1. WEB—a dramatic fall in web traffic. Most relevant to e-commerce sites where revenue is directly tied to such traffic, although also relevant to non-transactional websites since no one wants to see far fewer visitors for any reason.
A. Pricing—based on the frequency of web-wide ‘failures’.
B. Payout—warranty options may include three separate warranties with payouts of $250K, $500K and $1 million, respectively.
C. Trigger—the relevant network exhibits traffic drops in the range of 75% to 99% below the corresponding normalcy figure for a period of at least 24 hours.

2. DOS—a dramatic fall in ‘effective latency’ even though there may be a rise in web traffic, as illustrated by a DOS attack.
A. Pricing—based on the frequency of web-wide DOS attacks.
B. Payout—warranty options may include three separate warranties with payouts of $250K, $500K and $1 million, respectively.
C. Trigger—the relevant effective latency becomes at least 5× worse than the corresponding normalcy figure for a period of at least four hours.

3. IPP—a dramatic fall in Internet Protocol (IP)-packet traffic. Relevant for the health of Internet-connected networks that may not necessarily be related to web applications.
A. Pricing—based on the frequency of Internet-wide IP-traffic drops.
B. Payout—warranty options may include three separate warranties with payouts of $250K, $500K and $1 million, respectively.
C. Trigger—the relevant effective latency becomes at least 5× worse than the corresponding normalcy figure for a period of at least four hours.

The examples above, and their details, are merely illustrative.

Examples of custom warranties include:

1. SGX—specific to a particular cyber-security firm. By way of example, assume that this cyber-security firm keeps its client safe(r) by detecting malware signatures on their machines. This is a warranty that pays out if a known signature is detected despite this firm's best efforts. Pricing can be determined with reference to this firm's historical experience with its client base.
A. Pricing—based on this firm's experience of ‘failures’.
B. Payout—warranty options may include three separate warranties with payouts of $250K, $500K and $1 million, respectively.
C. Trigger—the relevant network exhibits traffic drops in the range of 75% to 99% below the corresponding normalcy figure for a period of at least 24 hours.

2. SLX—specific to a particular hosting firm. By way of example, assume this firm offers an SLA (service level agreement) to its clients. When/if the SLA fails, the ‘penalty’ is usually something like ‘free service for N months.’ For the client, however, the prospect of free service may not be very interesting since they may have lost 1000 times as much revenue during the outage. Hence the need for an SLA warranty that pays significant dollars.
A. Pricing—based on the frequency of SLA failures at this firm.
B. Payout—warranty options may include three separate warranties with payouts of $250K, $500K and $1 million, respectively.
C. Trigger—there is an SLA outage lasting more than 1 hour.

The examples above, and their details, are merely illustrative.

Warranty types that have been approved by risk partners up to a level of 100% underwriting support can be prepared for sale by the warranty administrator. A warranty type that has been prepared for sale includes the following:
It has a complete price stack (e.g., basic price, multiple-unit discount, best-practices factor and so on) as well as the underlying logic for those prices.
It has a defined trigger condition.
It has a defined payout.
It has a defined coverage period.
It cannot be sold before a specific date.

With reference to FIG. 2, the baseline operating parameters are established with a series of scans, including:

Inventory Scan (S9)—at least one scan will be performed which establishes the buyer's inventory. The warranty administrator needs to determine which ‘nodes’ (e.g. servers) are covered by the warranty and which are not. This is because, if the warranty covers some type of failure of a node, then the probability of failure rises with the number of nodes. The covered nodes may be ‘marked’ using suitable markers (e.g., token, interactive function, external recognition, etc.) (S10).

Verification Scan (S11)—at least one scan will be performed which establishes ‘best practices’, e.g. version of operating system running and security patches that are applied or not applied. For each covered node, the warranty administrator needs to determine whether that node is already doing best practices. For example, a server is running some specific OS version. Maybe it is new, maybe not. Maybe they have applied a range of security patches, maybe not. Depending on the nature of the warranty, what constitutes ‘best practices’ may vary.

Reference Scan (S12)—at least one scan will be performed that establishes ‘normalcy’ or baseline operating parameters. If the warranty says that it triggers due to an 80% drop below normal, for example, this scan determines normalcy for both the to-be-warranted target as well as a plurality of reference targets (e.g., 100 reference targets). ‘Normal’ may vary by time of day as well as day of week, so the warranty administrator needs to look for the reference ‘pattern’ rather than a reference ‘number’. Note that if the warranty administrator runs this scan over a longer period of time, e.g., seven days, the warranty administrator can determine variation by time of day and day of week, but not time of year, which may be highly relevant to (for example) sites that depend on holiday traffic.

Trigger Scan (S6 in FIG. 1)—at least one scan will be performed that determines if the trigger condition has fired or not. It is desirable to avoid the following scenarios during the trigger of a warranty:

1. A deviation from normalcy that is not ‘dramatic’.

2. An event that does not last long enough to be meaningful,

3. An event that is specific to the target rather than general in the sense of a widespread attack/outage—so we avoid systemic risk.

Thus the trigger definition and the objective of the trigger scan, should contain at least the following types of clauses:

1. A definition of deviation that is truly dramatic (e.g. web traffic drops by 85%).

2. The deviation lasts for a meaningful time (e.g. web traffic drops over at least 24 hours)

3. The warranty administrator tracks multiple reference sites and the problem is seen to be more or less unique to the warranted target, and not an across-the-board problem which would suggest a major outage or state-sponsored attack or similar.

The process of selling a warranty is accomplished through any of the following methods:

1. Referral—here the distributor only ‘refers’ end-clients to the warranty administrator website where the relevant warranty is available for sale.

2. Embedded Distribution—here the distributor embeds the warranty administrator-provided capability into its own website, such that the end-clients of this distributor can buy a warranty.

3. API Distribution—here the distributor uses the warranty administrator-provided distribution API to build its own warranty-sale UI for use in its own website.

The assumption is that the same API in (3) above, is also used to offer (1) and (2) above.

Lifecycle

INTEREST—A potential buyer expresses interest in buying a warranty of some type. This is expressed, for example, by going to a relevant website and arriving at a point where detailed information about that warranty type is available and a rough price range is available, and a GET PRICE button or the like is selected to initiate the purchase process. (“GET PRICE” basically implies that while a rough price range is available, it is not possible to quote an exact price for a warranty until the warranty administrator examines the items the buyer wants covered by the warranty).

GET PRICE—If the user clicks the GET PRICE button, the warranty administrator asks the buyer to provide one or more domains or IP addresses or similar and offers a free-of-charge ‘introductory scan’ to the buyer. If the buyer enters the information and provides permission to proceed, the warranty administrator performs the introductory scan (specifically, the inventory and verification scans), which identifies the following:
Which nodes will be covered by the warranty
Which operating system and version is running on each node
Based on the previous point, which patches, security or otherwise, have been applied
Based on this, an exact price can be determined
The warranty administrator also checks whether this buyer and/or these nodes are already covered by some other warranty, or were covered in the past.

EXACT PRICE—The results of the introductory scan including the exact price are provided to the buyer and the buyer is provided an opportunity to buy the warranty. The buyer may be told the following:
Any purchased warranty will perpetually auto-renew unless cancelled, immediately upon ending of the previous warranty, so the buyer is never not covered.
The buyer will always be informed in advance of renewal, what the terms/price of the renewal are.
In any case, the buyer can always log into the appropriate web page and see the current status of the warranty and modify/cancel it if so desired.
The warranty preferably only covers ONE (1) firing of the trigger condition during any coverage period (multi-fire warranties may be available at some price premium). If the warranty fires, it is auto-renewed but at a possibly different price.
Although they can buy the warranty right away and although it covers a period of 30 days, its coverage will not start right away. In fact, the start of coverage may depend on two things:

1. Receipt of the warranty fee by the warranty provider, and

2. Completion of the reference scan (for which a promised done-by date/time is provided) and its acceptance by the buyer.

PURCHASE—The buyer buys the warranty. The reference scan starts. Once it ends, and assuming the warranty fee has been received, the buyer is provided with the results and invited to accept them. If the buyer chooses to reject them, the warranty fee is returned, less the cost of the scan if any. If the buyer chooses to accept them, the warranty coverage period begins and will run for a specified time, e.g., 30 days.

COVERAGE PERIOD START—Throughout the coverage period, the trigger scan may be run to check if the trigger condition fired or not (active monitoring). If it did not fire during the coverage period, then nothing happens, and the trigger scan ends when the coverage period ends. If it fired, then the PAYOUT process starts.

COVERAGE PERIOD END—at the end of any coverage period, the warranty is internally converted from ‘ACTIVE’ to ‘OLD’ i.e., it becomes of historical interest, but is no longer in effect. The warranty administrator can provide the buyer with the results of the reference and trigger scans so that they can see the patterns, even if nothing triggered.

CANCELLATION—At any point, the buyer can cancel the service, but in a preferred embodiment, they are only cancelling the renewals. That is, preferably, any warranty period, once begun, cannot be cancelled. Once a warranty is cancelled, there is no reinstatement, i.e., a new warranty can of course be purchased but it may not take advantage of any of the work done for any previous warranty.

RENEWAL—Assuming that it takes N days to run the reference scan and a few minutes to run the inventory and verification scans, then N+1 or N+2 days before any existing warranty is scheduled to end, the inventory and verification scans are run to check if something has changed on the covered nodes compared to the last time they were run. Once the exact price is determined, the buyer is informed that the warranty will renew at the new price, immediately upon the end of the current warranty.

PAYOUT—if the trigger condition fires, the relevant risk partners are promptly informed and the payout is made and tracked. Furthermore, and automatically, the warranty immediately expires, and if the system is able to support the sale of one more warranty of this type, then the expired warranty is replaced by another warranty that covers the period remaining in the original warranty, and the (possibly higher) fee for this new warranty is deducted from the payout before the payout is sent to the beneficiary. The new warranty kicks in only if the trigger-fire condition has been ‘fixed’.

Some examples of distributors through which such warranties can be sold, are provided below. In most cases, the distributor sells the warranty as an ‘add-on sale’, i.e., they already sell products/services to their clients, and may sell one or more warranties to the same clients, often as items that add value to what they already sell.

1. Hosting Providers, Cloud Providers, Managed-Cloud Companies: Warranties may be purchased by clients of these companies, e.g., a client might buy a warranty which says that if this client's computing resources are misused in defined ways, a payout is triggered.

2. Cyber-Security Companies: these companies normally sell products and services intended to sharply reduce the odds of ‘bad things’ happening to their clients. They can sell warranties as companions for the products/services they normally sell, and if despite their best efforts a defined ‘bad thing’ does happen at one of their clients, a payout is triggered.

3. System Integrators: these companies are hired to alter their client's IT resources/configuration and inevitably, the first few months of any such project are likely destabilizing, with the consequent need for warranties.

A further aspect of the described embodiments relates to a platform that supports all aspects of this type of warranty offering. The platform is applicable to the technology warranty described with reference to FIGS. 1-3 above and is more broadly applicable to any condition-based warranty program. In some embodiments, the system and methodologies for the platform include the following:

(1) WARRANTY TYPE DEFINITION (S13)—the ability to define a new warranty type or manage the details of an existing warranty type. This includes a description of the warranty, the amount/range of its payout and a definition of the conditions that lead to its payout becoming due.

(2) WARRANTY PRICING (S14)—detailed analysis of the circumstances in which a warranty of a given type might trigger and the probability of this occurrence and thus the price to be charged for a warranty of this type, given its payout. This may include both a sense of the “average” or “typical” payout frequency in any given time period, as well as a “worst-case” payout estimation for the same time period.

(3) TRIGGER SCANNING (S15)—once a particular warranty (of any type) has been sold, there needs to be a mechanism to determine whether and when this warranty fires, i.e., whether and when a payout is required. Depending on the type of warranty, this may involve pre-emptive scanning by the system administrator or it may involve analysis by the system administrator of circumstances reported by the warranty buyer, or both.

(4) LIFECYCLE MANAGEMENT (S16)—a way to deal with all of the possible circumstances that may occur once a particular warranty is sold. The list includes at least the following:

a. The ability to display the “base price” of a given warranty type.

b. If relevant, a detailed analysis of the potential warranty buyer to determine whether and how to modify this base price for this buyer—which may include the decision to not sell a warranty at all.

c. The recognition that a warranty has been sold, and notification of the relevant risk partner of the transaction.

d. The acceptance of payment for the warranty and its management as an accounting transaction and the handling of any overpayment or underpayment by the warranty buyer.

e. Notification of the relevant risk partner of the portion of the warranty fee due to them.

f. Enablement of trigger scanning (as described above) once the in-force period of the warranty starts.

g. Identification/confirmation of a firing event (i.e., a circumstance when a payout becomes due) and notification of all relevant parties.

h. Termination of trigger scanning once the in-force period of the warranty ends.

i. Execution of the logic related to the renewal of the warranty when its in-force period ends.

j. Execution of the logic related to the reinstatement of the warranty when it is cancelled or a firing event occurs.

k. Management of information about the warranty once its in-force period ends.

l. Periodic aggregate reports about warranties to various involved parties.

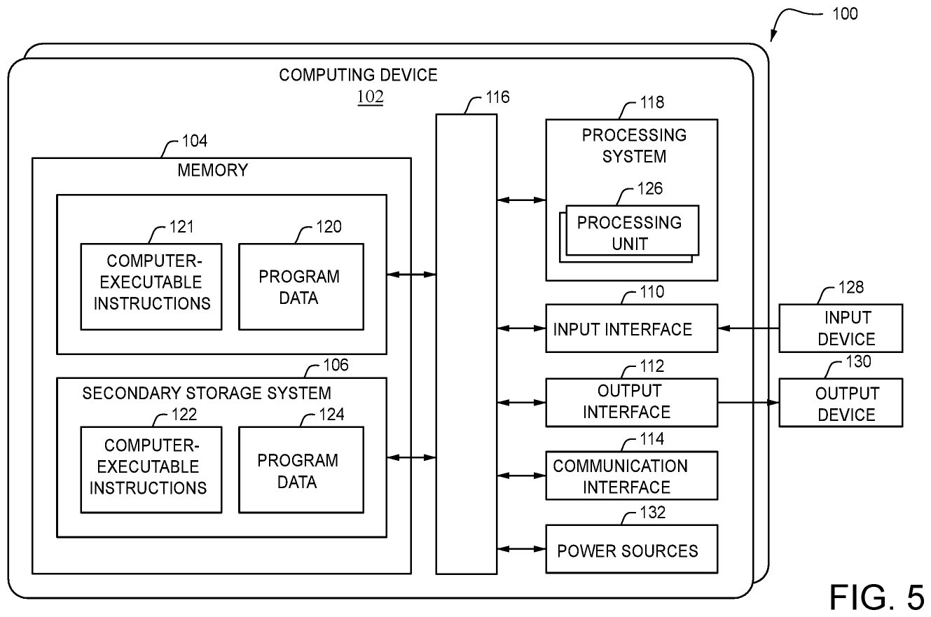

In some applications, the system is administered using a computer system. Any known computer configuration capable of carrying out the intended functionality of the preferred embodiments may be used. FIG. 5 is a block diagram of an example configuration of a computer system 100 in which the techniques of this disclosure may be implemented. In the example of FIG. 5, computer system 100 comprises a computing device or control circuit 102 and one or more other computing devices. Computer system 100 or similar computing systems implement the system. Computing device 102 is an electronic device that processes information. In the example of FIG. 5, computing device 102 comprises a data storage system 104, a memory 108, a secondary storage system 106, a processing system 118, an input interface 110, an output interface 112, a communication interface 114, one or more power sources 132, and one or more communication media 116. Communication media 116 enable data communication between processing system 118, input interface 110, output interface 112, communication interface 114, memory 108, and secondary storage system 106. Computing device 102 can include components in addition to those shown in the example of FIG. 5. Furthermore, some computing devices do not include all of the components shown in the example of FIG. 5. Each of components 104, 106, 108, 110, 112, 114, 116, 118, 120, 121, 122, 124, 126, 128, 130, and 132 can be interconnected (physically, communicatively, or operatively) for inter-component communications.

Data storage system 104 is a system that stores data for subsequent retrieval. In the example of FIG. 5, data storage system 104 comprises memory 108 and secondary storage system 106. Memory 108 and secondary storage system 106 store data for later retrieval. In the example of FIG. 5, memory 108 stores computer-executable instructions 121 and program data 120. Secondary storage system 106 stores computer-executable instructions 122 and program data 124. Physically, memory 108 and secondary storage system 106 each comprise one or more computer-readable storage media.

A computer-readable medium is a medium from which a processing system can read data. Computer-readable media include computer storage media and communications media. Computer storage media can further include physical devices that store data for subsequent retrieval. Computer storage media are not transitory. For instance, computer storage media do not exclusively comprise propagated signals. Computer storage media include volatile storage media and non-volatile storage media. Example types of computer storage media include random-access memory (RAM) units, read-only memory (ROM) devices, solid state memory devices, optical discs (e.g., compact discs, DVDs, BluRay discs, etc.), magnetic disk drives, electrically-erasable programmable read-only memory (EEPROM), programmable read-only memory (PROM), magnetic tape drives, magnetic disks, and other types of devices that store data for subsequent retrieval. Communication media includes media over which one device can communicate data to another device. Example types of communication media include communication networks, communications cables, wireless communication links, communication buses, and other media over which one device is able to communicate data to another device.

Referring again to FIG. 5, processing system 118 is coupled to data storage system 104. Processing system 118 reads computer-executable instructions (e.g., 121, 122) from data storage system 104 and executes the computer-executable instructions. Execution of the computer-executable instructions by processing system 118 configures and/or causes computing device 102 to perform the actions indicated by the computer-executable instructions. For example, execution of the computer-executable instructions by processing system 108 can configure and/or cause computing device 102 to provide Basic Input/Output Systems (BIOS), operating systems, system programs, application programs, or can configure and/or cause computing device 102 to provide other functionality.

Processing system 118 reads the computer-executable instructions from one or more computer-readable media. For example, processing system 118 reads and executes computer-executable instructions 121 and 122 stored on memory 108 and secondary storage system 106.

Processing system 118 comprises one or more processing units 126. Processing units 126 comprise physical devices that execute computer-executable instructions. Processing system 118 can also include one or more operating systems that are executable by computing device 102. Processing units 126 comprise various types of physical devices that execute computer-executable instructions. For example, one or more of processing units 126 comprise a microprocessor, a processing core within a microprocessor, a digital signal processor, a graphics processing unit, or another type of physical device that executes computer-executable instructions.

Input interface 110 enables computing device 102 to receive input from an input device 128. Input device 128 comprises a device that receives input from a user. Input device 128 comprises one or more various types of devices that receive input from users. For example, input device 128 comprises a keyboard, a touch screen, a mouse, a microphone, a keypad, a joystick, a brain-computer interface device, or another type of device that receives input from a user. In some examples, input device 128 is integrated into a housing of computing device 102. In other examples, input device 128 is outside a housing of computing device 102.

Output interface 112 enables computing device 102 to output information on one or more output devices 130. One or more output devices 130, in some examples, are configured to provide output to a user using tactile, audio, or video output. For example, an output device 130 is a device that displays output. Example types of display devices include monitors, touch screens, display screens, televisions, and other types of devices that display output. In some examples, output device 130 is integrated into a housing of computing device 102. In other examples, output device 130 is outside a housing of computing device 102. Output devices 130, in one example, includes a presence-sensitive screen or a touch screen. Output devices 130 can utilize a sound card, a video graphics adapter card, or any other type of device for converting a signal into an appropriate form understandable to humans or machines. Additional examples of output device 130 include a speaker, a cathode ray tube (CRT) monitor, a liquid crystal display (LCD), or any other type of device that can generate intelligible output to a user.

Communication interface 114 enables computing device 102 to send and receive data over one or more communication media. In some examples, computing device 102 utilizes one or more communication interfaces 114 to wirelessly communicate with an external device such as server device or a client device, a mobile phone, or other networked computing device. Communication interface 114 comprises various types of devices. For example, communication interface 114 comprises a Network Interface Card (NIC), a wireless network adapter, a Universal Serial Bus (USB) port, or another type of device that enables computing device 102 to send and receive data over one or more communication media. In some examples, communications interface 114 comprises a network interface to communicate with external devices via one or more networks, such as one or more wireless networks. Examples of communications interface 114 are an Ethernet card, an optical transceiver, a radio frequency transceiver, or any other type of device that can send and receive information. Other examples of such network interfaces include Bluetooth®, cellular (e.g., 3G, 4G, 5G) and Wi-Fi® radios in mobile computing devices. In some examples, communication interface 114 receives configuration data, trial data, and/or other types of data as described above. Furthermore, in some examples, communication interface 114 outputs information and/or other types of data as described above.

Computing device 102, in some examples, includes one or more power sources 132, which may be rechargeable and provide power to computing device 102. In some examples, the one or more power sources 132 are one or more batteries. The one or more batteries could be made from nickel-cadmium, lithium-ion, or any other suitable material. In another example, the one or more power sources 132 include a power supply connection that receives power from a power source external to computing device 102.

The techniques described herein may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described herein. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described herein may also be embodied or encoded in a computer-readable medium, such as a computer-readable storage medium, containing instructions. Instructions embedded or encoded in a computer-readable medium, including a computer-readable storage medium, may cause one or more programmable processors, or other processors, to implement one or more of the techniques described herein, such as when instructions included or encoded in the computer-readable medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may comprise one or more computer-readable storage media.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of establishing a condition-based warranty program, the method comprising:
(a) defining a warranty type including a description of the warranty, an amount or range of a payout and a definition of conditions that trigger the payout;
(b) measuring a probability of the trigger and determining a warranty price based on the measured probability and based on the amount or range of the payout;
(c) establishing a first mechanism to determine whether and when the trigger has occurred, and establishing a second mechanism to determine whether and when the payout is required; and
(d) establishing protocols for warranty lifecycle management to manage possible circumstances that may occur once a particular warranty is sold.

2. A method according to claim 1, wherein step (b) includes an average payout frequency in any given time period, and a worst-case payout estimation for the given time period.

3. A method according to claim 1, wherein step (c) is practiced with preemptive scanning.

4. A method according to claim 3, wherein step (c) is further practiced by administrator analysis of circumstances reported by a warranty purchaser.

5. A method according to claim 1, wherein step (c) is practiced by administrator analysis of circumstances reported by a warranty purchaser.

6. A method according to claim 1, wherein step (d) is practiced by defining a pricing protocol to determine whether and how to modify the warranty price.

7. A method according to claim 1, wherein step (d) is practiced by defining communication protocols to notify a risk partner about the particular warranty.

8. A method according to claim 7, wherein the communication protocols include further notifications to the risk partner about a partner warranty fee due to the risk partner.

9. A method according to claim 1, wherein step (d) is practiced by defining payment processing protocols to accept payment for the particular warranty.

10. A method according to claim 1, wherein step (d) is practiced by defining data-gathering protocols to activate the first and second mechanisms.

11. A method according to claim 10, wherein step (d) is further practiced by defining payout protocols to identify and confirm the trigger and to authorize the payout.

12. A method according to claim 1, wherein step (d) is practiced by defining termination protocols to deactivate the first and second mechanisms when an in-force period of the warranty ends.

13. A method according to claim 12, wherein step (d) is further practiced by defining renewal protocols to enable warranty renewal when the in-force period of the warranty ends, when the warranty is canceled, or after the trigger.

14. A method according to claim 1, wherein step (d) is practiced by defining reporting protocols to generate aggregate warranty reports.

15. A method of establishing a condition-based warranty program, the method comprising:
(a) defining a warranty type including a description of the warranty, an amount or range of a payout and a definition of conditions that trigger the payout, wherein the conditions are objectively identifiable and verifiable after occurrence;
(b) measuring a probability of the trigger and determining a warranty price based on the measured probability and based on the amount or range of the payout;
(c) establishing a first mechanism to determine whether and when the trigger has occurred, and establishing a second mechanism to determine whether and when the payout is required; and
(d) establishing protocols for warranty lifecycle management to manage possible circumstances that may occur once a particular warranty is sold,
wherein step (b) includes an average payout frequency in any given time period, and a worst-case payout estimation for the given time period,
wherein step (d) is practiced by defining a pricing protocol to determine whether and how to modify the warranty price, wherein step (d) is practiced by defining payment processing protocols to accept payment for the particular warranty, wherein step (d) is practiced by defining data-gathering protocols to activate the first and second mechanisms, and wherein step (d) is practiced by defining payout protocols to identify and confirm the trigger and to authorize the payout.

16. A method according to claim 15, wherein step (d) is further practiced by defining communication protocols to notify a risk partner about the particular warranty.

17. A method according to claim 16, wherein the communication protocols include further notifications to the risk partner about a partner warranty fee due to the risk partner.

18. A method according to claim 15, wherein step (d) is practiced by defining termination protocols to deactivate the first and second mechanisms when an in-force period of the warranty ends.
